(19) United States
(12) Patent Application Publication
(10) Pub. No.: US 2006/0085328 A1
(43) Pub. Date: Apr. 20, 2006

(54) Secure online commerce transactions

(75) Inventors: Thomas Andrew Cohen, Cottesloe (AU); Andrew Yeng Hao Wong, Paddington (AU)

Correspondence Address: BANNER & WITCOFF, 1001 G STREET N W, SUITE 1100, WASHINGTON, DC, 20001, US

(73) Assignee: Aceinc Pty Ltd., West Perth (AU)

(21) Appl. No.: 11/080,472

(22) Filed: Mar. 16, 2005

Related U.S. Application Data
(63) Continuation of application No. 10/686,767, filed on Oct. 17, 2003, now abandoned.
Application No. 10/686,767 is a continuation of application No. 09/604,689, filed on Jun. 27, 2000, now abandoned.
Application No. 09/604,689 is a continuation-in-part of application No. 09/544,499, filed on Apr. 7, 2000, now abandoned.

(30) Foreign Application Priority Data
Jun. 28, 1999 (AU) PQ 1265
Apr. 8, 1999 (AU) PP 9660

(51) Int. Cl. G06Q 40/00

(52) U.S. Cl. 705/39

(57) ABSTRACT

A method of enabling electronic commerce transactions is provided by a service, the service giving to users a disposable credit card or other indicia of credit for a particular transaction or amount. The service receives registration information from the user and authorizes the user. The service establishes an account for the user and issues a disposable (one use) credit card number to the user which has the same format as a permanent credit card number, is acceptable to the user and the institution with whom the user is transacting business. The system incorporates various security features.

### FIELD OF THE INVENTION

The invention relates to online commerce transactions such as the purchase of goods and services and more particularly to methods and devices for the issue of ‘disposable’ credit cards which operate (depending on user defined options) either as credit cards with a positive cash balance and a zero credit limit or as aliases for real credit cards so as to provide secure transactions.

### BACKGROUND OF THE INVENTION

It is an established fact that one of the major impediments to a wider public acceptance of the online purchase of goods and services (‘e-commerce’) is reluctance on the part of many people to disclose their credit card number on the Internet. Irrespective of the real incidence of credit card fraud online, or the efficacy of the standard Internet secure communications channels, the common perception remains that online purchasing brings with it a significant risk of fraud.

Nonetheless, e-commerce is a rapidly growing economy, evidencing support for the convenience and pricing/transaction models that characterise this commerce sector. It is reasonable to assume, therefore, that a system that enables consumers to participate with confidence will be welcomed both by consumers and e-commerce merchants. The acceptance of such a system will be all the more widespread, if it achieves this end without limiting a purchaser's access to web sites (for instance, by making a prior relationship or proprietary communications protocols preconditions to any representation of security).

### OBJECTS AND SUMMARY OF THE INVENTION

The present system has been designed to provide such security (and, in one option, anonymity) while providing universal access to all and any e-commerce commerce web sites. The present system is independent of the actual purchase medium, and could equally be applied to telephone transactions as it is to Internet based e-commerce or other off or on-line transactions which require a credit card number.

The system of the present invention provides the issue of ‘disposable’ credit cards which operate (depending on user defined options) either as credit cards with a positive cash balance and a zero credit limit or as aliases for real credit cards. In either case, a credit account (on each occasion it is issued) is valid only for a single transaction of a precise, known amount. Also, as the account is completely created before the user executes the purchasing transaction. The present invention will even work where the online merchant seeks real time authorisation before providing access to goods or (more commonly) services—such as pay per view, subscription sites, etc.

Accordingly, there is provided a method of transacting electronic commerce comprising the steps of: establishing a secure Internet connection between a special purpose client and a central server, using the special purpose client to register a user and to obtain credit card details from the user, the user's credit card having an issuer remote from the central server, obtaining a request over the Internet from the user to the central server for a disposable credit card, establishing a secure connection between the central server and a central bank by a closed network, obtaining funds authority from the central bank by the closed network, and supplying the user with a disposable credit card over the Internet after funds authority has been received.

In a preferred embodiment of the invention, the obtaining of funds authority is based on the supply of the user's credit card details to the remote issuer.

In another preferred embodiment, the obtaining of funds authority is based on funds authority details which are not directly associated with the user but rather with another commercial entity so that the transaction as between issuer, user and a merchant (from which the user purchases using the disposable card) remain anonymous.

In a further preferred embodiment, the special purpose client is not a web browser and is adapted to utilise 1024 bit RSA cryptology.

In another advantageous embodiment of the invention, the server communicates with a remote issuer through a central bank which recognizes the central server as a customer.

In a preferred configuration, the central bank acts as an intermediary between a merchant's bank and a user.

In other embodiments, multiple forms of security are provided for or allowed for in a loan or rental of the disposable card—eg, another credit card, a cash deposit or another bank account.

In some preferred versions cash will be received as security or payment for the disposable card.

In other preferred embodiments the client software captures the user's IP address and the URL of a transaction site.

### BRIEF DESCRIPTION OF THE DRAWINGS

In order that the invention may be more readily understood and put into practical effect, reference will now be made to the accompanying drawings in which:

FIG. 1 is a schematic diagram of networked hardware required for a user to make an electronic commerce purchase using the methods and devices of the present invention,

FIG. 2 is a schematic diagram of the client-side and server-side workflows in a web based registration process of the invention prior to a request for a disposable credit card,

FIG. 3 is a schematic diagram of the operation or workflow of the client when requesting a disposable credit card from the central server, and

FIG. 4 is a schematic diagram of the operation or workflow of the central server when meeting a request for a disposable credit card.

FIG. 5. is a schematic diagram of an alternate client-side and server-side workflows in a telephone based registration process of the invention prior to a request for a disposable credit card,

### BEST MODE AND OTHER EMBODIMENTS OF THE INVENTION

In this specification “credit card” may mean a credit or debit card unless a specific meaning is indicated. The term “disposable credit card” or “virtual card” means a number which resembles a conventional credit card number and which allows a user to transact business on-line or off-line as if the user were using a conventional credit card. Such a disposable or virtual card may have uses on-line or in conventional commerce transactions.

The security for the issue of the disposable card is either cash on deposit, a funds transfer from a valid credit card to the new account or an authorisation against a real credit card. The economic or commercial link between an account or a real card and a disposable card is held in secure database accessible to a central server.

Once debited with the amount of the transaction in respect of which it was issued, the disposable credit card account will have a zero balance and will be cancelled (and can subsequently be re-issued as explained below). From the merchant's perspective the disposable card number will appear completely normal, and it will be valid for the amount of the transaction.

The system of the present invention can be used with any off-line or online merchant accepting credit card payments. It requires no special or prior relationship between a user and a merchant. According to the option selected by the user at the time of each transaction, the system can provide a secure online payment system alone, or a secure online payment system coupled with anonymity. The system of the invention tackles, through a systemic approach, not only the issue of actual online security, but also, and more importantly, the consumer's perception of security.

Unlike some other systems, a central server may communicate with any number of banks, card issuers or institutions. It does this through a closed network link to each of the one or more central banks. A central bank is a bank or financial institution which recognises the central server as a customer. Only one central bank is required to implement the invention.

In some embodiments, the system of the present invention amounts to the loan or rental of temporary disposable credit cards—these operate (when allocated to a user) as ordinary credit cards with a positive cash balance and a zero credit limit. In all cases a virtual credit account (on each occasion it is issued), by virtue of the system's relationship with its issuing bank, is valid only for a single transaction of a precise, known amount. Also, as the allocation of the disposable card is completed before the user executes the online e-commerce transaction, the invention will even work where the online merchant seeks real time authorisation before providing access to goods or (more commonly) services—such as pay per view, subscription sites, etc.

As mentioned above, the security for the issue of the temporary or disposable card is a real time funds transfer from a valid credit card, a direct debit from an authorised bank account or a transfer from a cash deposit held in trust by the owner of the central server. In all cases the transfer will be to the server based operating account. The link between a real card, bank account or trust account and a temporary card is held in a secure database.

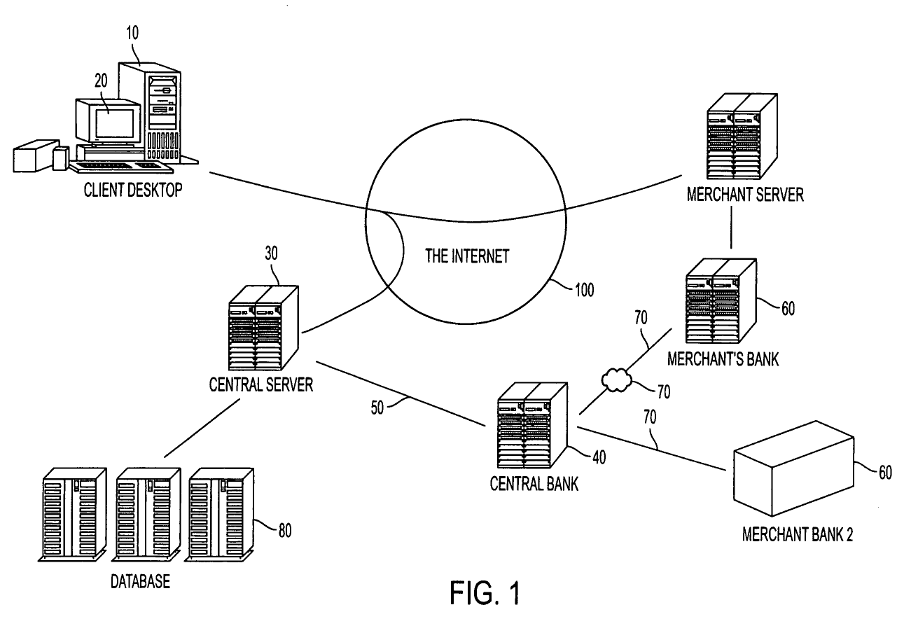

FIG. 1 is a diagram showing the relationship of the main elements in the present system. As technology and user behaviour changes, the system can also change without altering its fundamental premise—providing a secure payment method without limiting the freedom of consumers and merchants to transact with confidence on any medium, in any manner and at any time that is convenient to them both.

Unlike some other systems, a central server 30 may communicate with any number of banks, card issuers or institutions (“central tanks” for convenience) 40. It does this through a closed network link 50 to the one or more central banks 40. Each merchant bank, card issuer or institution 60 communicates only with a central bank 40 via a preferably closed or private or proprietary network 70 and there is no need for the merchant's bank to communicate with the user 10 over the Internet 100. A central bank 40 is one having authority within the terms of a credit card scheme to issue credit cards or credit card numbers or other instruments which are recognized by the participants in the scheme. The central bank 40 is in a sense like another merchant approaching a credit card facility for authorisation, acting on behalf of the user and the institution which bears the risk of non-payment. In another sense the central bank acts like a card issuer, directly providing funds to the user after having purchased funds in its own name from the user's credit card facility.

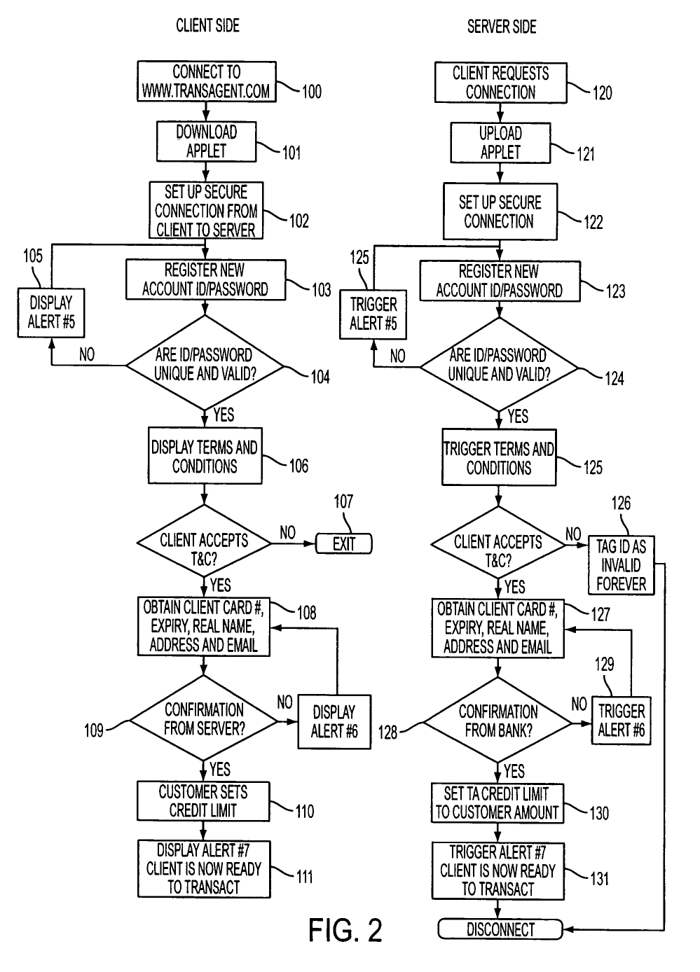

In one embodiment, and as shown in FIG. 2, the registration process commences with a consumer (‘user’) connecting to a web site 100. The user is then sent and then downloads a free application or applet 101 (the ‘client’) which will install itself on the user's PC 10 and create a desktop icon 20 (used to launch the application).

When the client is launched it will set up a secure communications channel 102 with the central server 30 (‘server’). The security on this channel will be RSA or similar (up to 1,024 bit encryption)—many times more secure than the usual 40-128 bit encryption used for browser-based SSL secure channels (including online banking). The high level of encryption offered is achievable because the client-server channel is a closed system—the client can and will only ever communicate with the server. Accordingly, the system of the invention does not need to comply with any lesser security standard supported by other sites and servers.

The client software will provide a ‘Register New Account’ option 103. As shown in FIG. 2, a new user will need to register a new virtual credit card account. An existing user can create additional accounts.

To register a new account, the user (whether a new or existing user) will select a user name (‘ID’) and password. The client then submits these to the server for confirmation 104 that the nominated ID does not already exist and that the ID and password are valid within the guidelines set for the system (eg length, use of symbols, etc.). If the ID and password are not unique and valid, the client will display a default message or alert 105 and will clear the input fields, allowing the user to select a new ID and password. This will continue until a unique and valid ID and password have been submitted to the server.

On receipt of confirmation of a unique and valid ID and password, the client will display the Terms and Conditions 106 of use and will request the user to indicate acceptance. If the user declines, the client will inform the server and exit 107. The server, on receipt of notification of non-acceptance, as a fraud minimisation strategy, will tag the nominated ID as invalid (precluding any subsequent user from registering an account in that name).

If the user accepts the Terms and Conditions, the client will ask for the user's credit card number, card expiry date, name (as printed on the credit card), billing address and e-mail address 108. The user will be advised that all information must be accurate, or the present system will not work. Only one credit card can be registered to an account (although the same credit card could be registered to more than one account). If a user wishes to use more than one credit card for online purchases, an additional account will be required for each card.

On receipt of these details, the server 30 will verify 109 with the central bank 40 that the credit card description is accurate and that the card is valid. If there has been an error or if the bank 40 advises the card has been stolen, etc., the client will erase the input fields and will ask the user to enter the requested information again.

If the card details are satisfactory, the server 30 will register them to the newly created account. Concurrently, the client will invite the user to set an irreversible credit limit for the account 110. Once set, for security reasons, the limit cannot be changed. If the user wants to change the credit limit a new account will be required.

When the server 30 has registered the account limit, the client will advise the user that the account as been established and that the user can now make secure (and optionally anonymous—see below) online purchases on any web site which accepts credit card payments from a card administered by the central bank 40. The client then disconnects from the server 30.

A schematic diagram of the server-side workflow in the registration process is also shown in FIG. 2.

From the server side perspective, and as illustrated in FIG. 2, the server responds to the client's request for a connection 120, then uploads the client applet to the user 121. The server then sets up a secure connection with the client 122. The server then registers the new account ID and password 123 after passing the ID and password for validity criteria 124. If the server detects a problem with the ID or password, it transmits an alert 125 to the client which displays the alert. If the password and ID are acceptable, the server causes the client to display the appropriate terms and conditions 125. If the reply from the client indicates that the terms and conditions were not accepted, then the ID is tagged by the server 126 as invalid forever. If the client's user accepts the terms and conditions , then the server requests and obtains the user's credit card number, expiry date, real name, physical address and email address 127. These details are confirmed with the issuing bank 128. If the details cannot be confirmed, an alarm within the client is triggered 129. An affirmative confirmation results in the user setting credit limits which are then transmitted to the server and used to setup a customer account 130. At this point, the server triggers an alert to the client that it is now ready to transact 131.

The client is not a browser, need not support general navigation and need not log the web site on which the online transaction is occurring. The client may contain or support hyperlinks. The user, having navigated in the normal manner using any browser, and having decided to make an online purchase, will complete the transaction exactly as prescribed by the site owner. The only departure from previous practice, is a substitution of a disposable credit card number for the user's usual credit card number. All other details required to be input by the user/purchaser (including address, card expiry date and cardholder's name) are unchanged.

The client is represented on the desktop by its own icon. It can be launched at any time. When not in use, the client can be minimised. The ‘initial’ state of the client contains, inter alia, a log-in frame consisting principally of two blank input fields, which invites the user to key in an ID and password. Typically a user would log-in immediately prior to making an online transaction. The client then runs concurrently with (but totally independent of) the user's browser. For security reasons the client does not remember the ID and password between sessions—those details must be re-entered each time the client is launched. Any number of users might therefore use a single client.

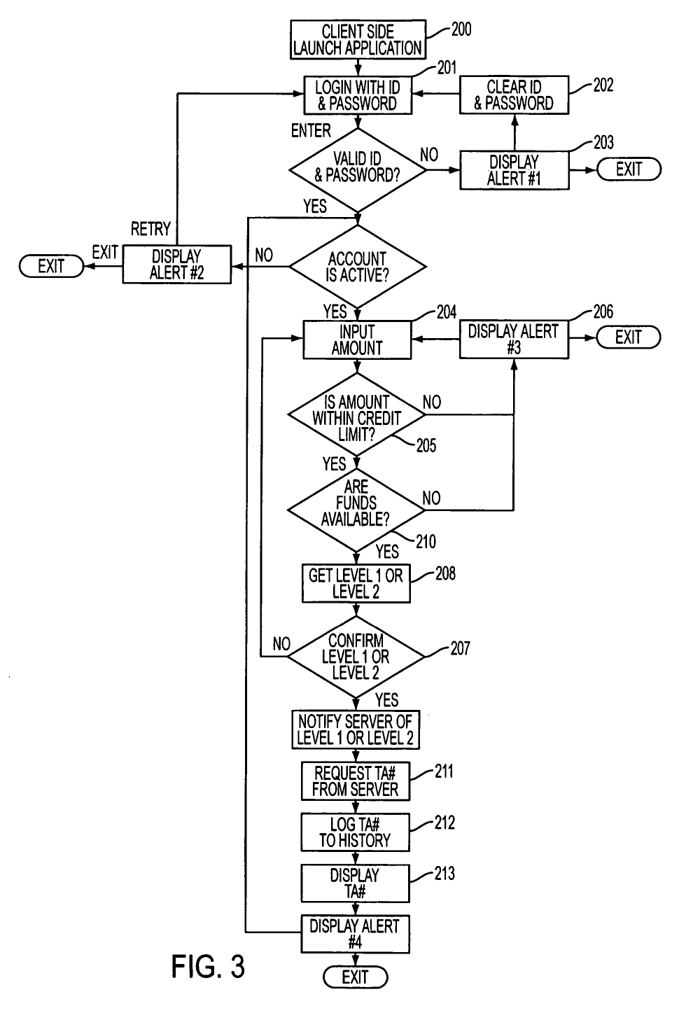

A schematic diagram of the normal operation of the client is shown in FIG. 3.

The client will set up 200, after it is launched a secure communications channel with the server 30 (with the same high level of encryption used during the registration process). If the log-in attempt 201 is unsuccessful (due to an error in either or both of the ID and password), an alert is displayed 203 and the log-in frame is cleared 202 and the user invited to try again.

On receipt of notification from the server 30 that the log-in was successful, and that the account is valid (see below), the client will open a frame with a value input field. (If the account is invalid, the client will give the user instructions for re-enabling the account, and will clear the log-in frame.) The user is invited to enter in this field the total amount of the online transaction 204 (as displayed on the vendor's web site). This amount will be checked against the user's account limit 205 (see above, under ‘Registration’) and credit card limit (by real time authorisation 210 between the server 30 and the bank 40). If the proposed transaction exceeds the user's account limit, or if the bank 40 declines to authorise a transaction of that amount on the user's credit card, the client will in due course notify 206 the user. The client will then clear the value input frame (allowing the user to try a lesser amount on another transaction without first having to log out and re-validate.

If the transaction value is within the account limit and funds are available on the user's credit card to cover the transaction, the user will be asked to request 208 then confirm 207 the request for a virtual credit card number with a credit limit of the amount entered. This request seeks a firm commitment from the user to proceed, and will allow the user to confirm 207 at one of two levels (Level 1 or 2). In either case the confirmation renders the transaction irreversible by the client.

A Level 1 confirmation will produce a secure online transaction in which the transaction details (including the online merchant) will appear on the user's credit card statement (as though the merchant had received the user's real credit card details). A Level 2 confirmation will produce a secure online transaction in which the user's credit card statement will note only a debit to the account by the entity that operates the system (server 30) of the present invention. Level 2 is considered a premium service and offers anonymity. A premium fee might be attached to the transaction. (A privacy policy will preclude disclosure of the identity of a user unless required by a valid court order.)

Once the confirmation has been given (at either level) the client will request 211, then log 212 then display 213 a disposable credit card number to the user. This disposable credit card number will be in the same format as any other credit card number. The user will enter or copy this number into the browser window. All other details entered into the browser window (including card expiry date, cardholder's name, etc.) will be exactly as they would be if the card were the user's usual credit card.

At this point the User's disposable credit card account is disabled. The user will receive by e-mail a digital receipt for the transaction and will be asked to confirm the transaction by returning the e-mail. Once the reply has been received, the user's account will be re-enabled. The user's account cannot be used again unless this reply is received.

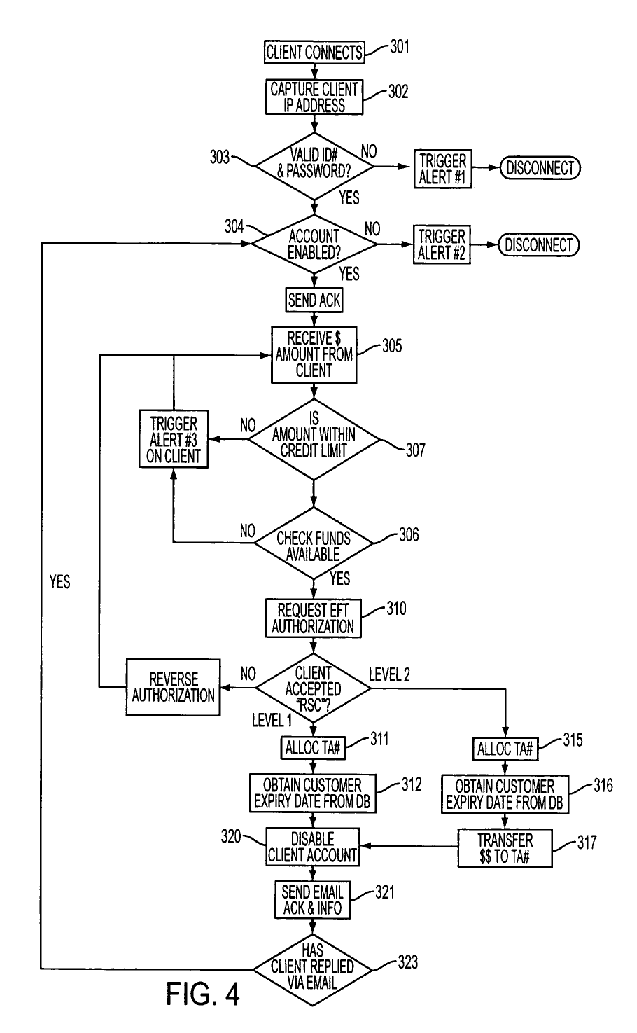

A schematic diagram of the normal operation of the server is shown in FIG. 4.

The server 30 has access to the disposable credit card account database 80 and has a real time credit card authorisation facility with a bank 40. The bank may be the central bank 40 or another bank chosen by the operators of the central server.

When the server 30 receives a connect request from a client, it establishes a secure communications protocol 301 (as for the registration process) and logs the client's IP address 302.

On receipt of requests from the client, the server 30, in sequence, confirms or denies (as appropriate) the log-in attempt 303, the validity of the account 304, the availability of credit 306 and compliance with the user-defined account limit 307. The server will determine its responses by reference to the databases and the bank's acceptance or refusal of the real time credit card authorisation request. When the server requests an authorisation 310 from the bank, it will place a temporary hold over the funds authorised.

Next the server 30 will receive either a Level 1 or Level 2 confirmation from the client.

A Level 1 confirmation will result in the server allocating and issuing to the user a disposable credit card account number 311. The number will be taken at random from the number range available to the server (and might be a number previously issued and cancelled). The disposable credit card account details (other than the number) will be taken 312 from the user's usual credit card account. The implication of a Level 1 confirmation is that when the merchant seeks authorisation against the disposable credit card account, the bank 40 will do a number translation via the disposable credit card database 80 and will allocate to the merchant the funds previously authorised on the user's credit card by the server. Accordingly, the user's credit card account will not be debited until the merchant seeks authorisation, but the merchant's name will appear on the user's credit card statement.

A Level 2 confirmation will result in the server issuing to the user a disposable credit card account number 315. The number will be taken at random from the number range available to the server (and might be a number previously issued and cancelled). The disposable credit card account details (other than the number) will be taken 316 from the user's usual credit card account. Concurrently, the server 30 will debit the user's card for the amount authorised and will credit that amount to the disposable credit card account 317 (or will provide a secured guarantee for a credit limit of the same amount). The implication of a Level 2 confirmation is that the transaction value will be debited immediately to the user's credit card account (as though the user were purchasing a stored value card of the same amount). When the merchant seeks authorisation against the disposable credit card account, the funds will be present in (or immediately available to) that account. Accordingly the user's credit card will show only a transaction with the disposable credit card provider and the merchant's name will not be disclosed.

In both cases the server will disable the user's account 320 and generate a digital receipt, which will be sent by e-mail 321 to the user's account address. On receipt of a reply 323 the server will re-enable the user's account.

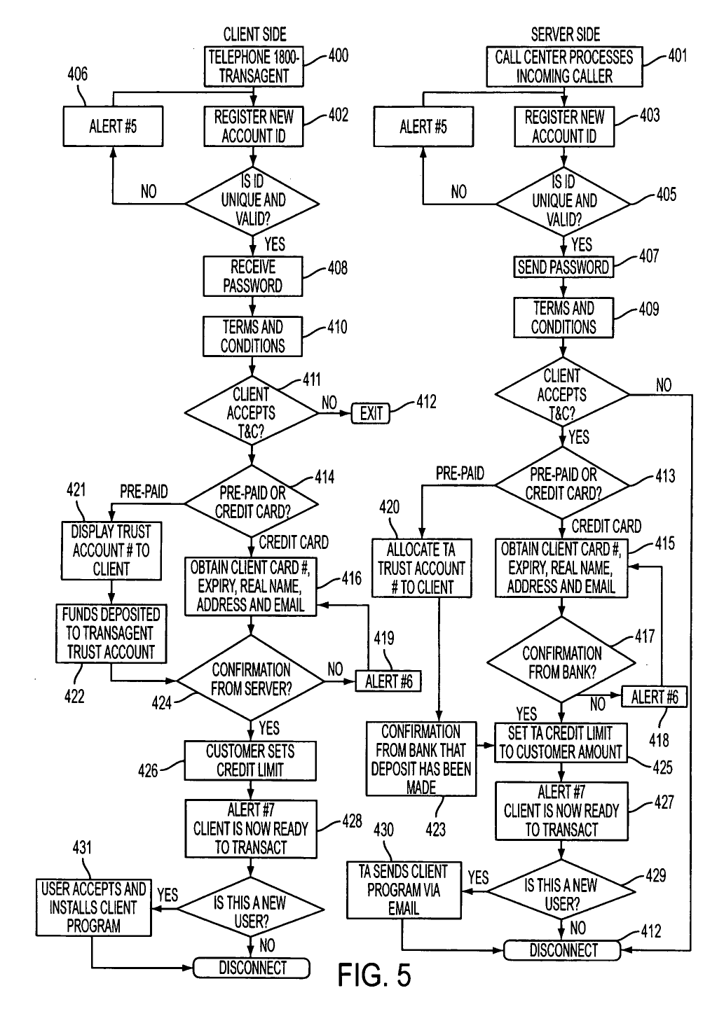

In other embodiments of the invention and as illustrated in FIG. 5, it may be advantageous to register customers by telephone. Telephone registration augments the sense of customer security by eliminating the need to transmit customer credit card details over the Internet. In this example, a customer telephones a toll free number such as an 800 number, 400. The call is taken by a live operator or IVRS 401. To register a new account, the user (whether new or existing) will select a user name (“ID”) 402. The ID is provided to the call centre and the ID data is then input by the call centre 403 into the central server 30 and its database 80 for confirmation 405 that the nominated ID does not already exist and that the ID is valid within the guide lines set for the system regarding ID length, use of symbols, etc. If the ID is not unique and valid, the user is alerted and requested 406 to select a new ID. This process will continue until a unique and valid ID has been submitted to the central server and subsequently confirmed.

On receipt of confirmation of a unique and valid ID, a password is issued by the server, sent to the customer 407 and received by a customer 408. The user or customer is then referred to the Terms and Conditions. The Terms and Conditions 409 may be obtained by the user from a website, transmitted to the user by fax or otherwise provided to the user fro example in an advertisement or brochure. The user then reads the terms and conditions and considers them 411. If the terms and conditions are not acceptable, the user may exit the registration process 412. If the user declines to accept the Terms and Conditions, the server 30, on receipt of notification of non-acceptance will tag the nominated ID as invalid and preclude any subsequent user from registering an account in that name.

If the user accepts the Terms and Conditions the user will be asked 413 to nominate the manner in which the account is to be operated. Options include credit card operations, direct debit operation or cash deposit operation. A decision is made by the customer 414. If the user selects the credit card option, the server 30 and thus the call centre will make a request 415 that the user submit 416 the customer's credit card details including credit card number, card expiry date, full name as printed on the credit card, billing address and e-mail address. The customer will be advised that all the information provided must be accurate, or the system will not work. Only one credit card can be registered to an account, although the same credit card could be registered to more than one account. If a user wishes to use more than one credit card for on-line purchasers, an additional account will be required for each additional credit card, On receipt of the customer's credit card details, the server or call centre operator will verify 417 with the appropriate bank that the customer's credit card description is accurate and that the card is valid. If there has been an error or if the bank advises that the card has been stolen or abused, etc., an alert 418 will be sent to the user and received by him 419 whereupon the user will be requested to provide the information again.

If the user selects the direct debit operation option, the customer will be requested to provide bank account details and will be asked to fax or e-mail a form from the central server's website to authorise the direct debit. In the case of a prepaid cash deposit operation option, the user will be allocated 420 a trust account number and that number will be displayed 421 to the customer. The customer will be requested to arrange a deposit to that account at a nominated physical location or may arrange for credit card deposit to the trust account over the telephone (or by other means). In this way, the customer provides funds 422 to the trust account, whereupon the server can confirm 423 that the appropriate deposit has been made.

If the credit card details are satisfactory or when he direct debit authorisation is received or when the cash deposit is received, the server can provide confirmation to both the call centre and the customer. 424 the server 30 will then register the card details, bank account details or the trust account details to the newly created account.

At this time, the user will be invited 425 and will accordingly set 426 an irreversible credit limit for their account. Once set, for security reasons, the limit cannot be changed. If the user wants to change the credit limit a new account will be required.

Once the irreversible credit limit has been established, the server or call centre will send an alert 427 to the customer that the account is ready to transact. This alert is received by the customer 428. If the call centre determines that the user is a new customer 429, then the server 30 is instructed 430 to e-mail or otherwise send to the user a free, self-installing application (client) which will install itself on the user's PC and create a desktop icon which is used to launch the client application. The user can then accept and install the client program on his PC 431. Each client program may have a unique ID number and inscription keys. Note that if the user is an existing user, the step of sending the client program may be omitted.

As mentioned, the client application is not a browser and need not support general navigation the client might be adapted to contain or support hyperlinks. Regardless of whether the customer has obtained his client program by Internet or telephone registration, the operation of the client program is the same. The client program allows the customer to obtain a temporary credit card which is then used exactly the same as a conventional credit card with any merchant, such as an e-commerce merchant, that will accept a credit card number in exchange for goods or services. Note that the transfer of the disposable credit card number and details from the client program to the customer's browser may be automated by the client by using ECML or a similar protocol. As with previous embodiments of the invention, the user's account is disabled after the disposable credit card number is provided. The customer will receive by (for example) e-mail, a receipt for their transaction and will be asked to confirm the transaction by returning the e-mail or correspondence. Once the reply has been received by the central server 30, the user's account will be re-enabled. The user's account cannot be used again until this reply is received.

It will be observed that some embodiments of the invention rely of a cash transfer or electronic fund transfer occurring prior to the allocation of the temporary or disposable credit card. In other embodiments, the allocation can be secured by an authorisation against a user's credit card. Obviously, this latter option is not available to users operating their accounts linked to a direct bank debit or trust account. When the disposable credit card is obtained by authorisation against the user's conventional credit card, a merchant's request for authorisation against the temporary card submitted by the user will result in the server 30 pointing the issuing bank to the user's conventional credit card and more particularly to the pre-authorised credit. The transaction will then appear on the user's credit card statement, identifying the merchant. While this approach does maintain the confidentiality of the identity of the user (from the merchant) and it does preclude fraud against the user's conventional credit card, it does not provide the user privacy on the credit card statement.

Various modifications in details of implementation of the secure online commerce transaction system of the invention may be made without departing from the scope and ambit of the invention.

1. A method of enabling electronic commerce transactions by a system which provides a disposable credit card to a user, comprising the steps of:
receiving registration information from a user and authorising the user based on that information;
establishing an account for the user, and
issuing the user with a disposable credit card number which has the same format as a credit card which is accepted by a merchant that the user will pay;
disabling the user's account after the disposable credit card number has been issued; and
re-enabling the account only after a reply to a transaction confirmation has been received.

2. The method of claim 1, wherein:
the issuance of the disposable credit card number is done with the authority of central bank which belongs to a credit card scheme.

3. The method of claim 1, further comprising the steps of:
seeking funds from a central bank at the request of the user and creating the user's account accordingly; and
not supplying the central bank with an identity of the user in respect of a request for credit by the central bank.

4. The method of claim 1, further comprising the step of:
obtaining a deposit in an account, from a user, from which deposit is used against the disposable credit card number.

5. (canceled)

6. The method of claim 1, further comprising the step:
prior to the completion of a user's purchase from the merchant, receiving funds;
the receiving accomplished by cheque or by debiting a user's credit card as though the user were purchasing a stored value card.

7. A method of making electronic commerce payments, comprising the steps of:
registering as a user with a service which provides disposable credit card numbers;
providing funds, or authority to seek funds, to the service;
obtaining from the service a disposable credit card number; and
providing that disposable credit card number to a merchant as a payment.

8. The method of claim 7, further comprising the step of:
obtaining the disposable credit card number by a request from a PC program which is not a browser.

9. The method of claim 7, whereby:
the providing of funds or authority to seek funds, and the obtaining of the disposable credit card number is performed in conjunction with a request, from the user of the service, that the service provide a direct credit at the time the request is made and that the service therefore appear as the creditor on any related financial statement.

10. The method of claim 7, wherein:
registration is accompanied by a nomination, by the user, of an irreversible credit limit.

11. The method of claim 8, whereby:
obtaining the disposable credit card number is accomplished by providing an ID and password before each request.

12. The method of claim 7, further comprising the step of:
replying, by e-mail, to a confirmation of a transaction sent by the service.

13. A method for crediting merchants comprising the steps of:
authorising an Internet based server to issue a disposable credit card number to a user;
receiving in respect of that disposable credit card number
a request for funds authority from the server by a closed network;
crediting a merchant or his merchant bank owing to a transaction by the user using the disposable credit card.

14. The method of claim 13, further comprising the step of:
verifying for the server, that a particular user's credit card description is valid.

15. The method of claim 13, further comprising the step of:
performing a real time authorisation for the server when a request is submitted by the server prior to a transaction between the user and the merchant.

16. The method of claim 13, further comprising the step of:
performing a number translation via a disposable credit card database, after receiving a request for credit from the merchant and before allocating credit to the merchant.

17. The method of claim 16, further comprising the step of:
providing the name of the merchant on a statement sent to the user.

18. The method of claim 13, further comprising the step of:
crediting the server, when requested to do so by a service operating the server so that the service and not the merchant appears on a statement sent to the user.

19. The method of claim 1 wherein:
issuing the user with the disposable credit card is accomplished over the Internet, between a server operated by the system and a client operated by the user, where the client is not a browser and communicates over the Internet only with the server.

20. The method of claim 2 wherein:
issuing the user with the disposable credit card is accomplished over the Internet, between a server operated by the system and a client operated by the user, where the client is not a browser and communicates over the Internet only with the server.

21. The method of claim 3 wherein:
issuing the user with the disposable credit card is accomplished over the Internet, between a server operated by the system and a client operated by the user, where the client is not a browser and communicates over the Internet only with the server.

22. A computer readable medium for operation with a computer processor and a data transmitter to perform a method of enabling electronic commerce transactions by a service, the service providing a disposable credit card to a user, the computer readable medium comprising computer code for executing the method comprising the steps of:
transmitting identification information from a user; and
receiving from the service a disposable credit card number that is transaction specific and having the same format as a credit card number acceptable to a merchant linked to said service.

23. A method of transacting electronic commerce comprising the steps of:
establishing a secure Internet connection between a special purpose client and a central server, using the special purpose client to register a user and to obtain credit card details from the user, the user's credit card having an issuer remote from the central server;
forwarding a request over the Internet from the user to the central server for a disposable credit card, establishing a secure connection between the central server and a central bank by a closed network;
obtaining funds authority from the central bank by the closed network, and supplying the user with a disposable credit card over the Internet after funds authority has been received.
